(19) United States
(12) Patent Application Publication
(10) Pub. No.: US 2026/0366914 A1
(43) Pub. Date: Nov. 19, 2026

(54) SINGLE-PHOTON AVALANCHE DIODE SYSTEM FOR AMBIENT LIGHT SENSING

(71) Applicant: STMicroelectronics International N.V., Geneva (CH)

(72) Inventor: Filip Mateusz Kaklin, Edinburgh (GB)

(21) Appl. No.: 19/209,509

(22) Filed: May 15, 2025

(51) Int. Cl. G01J 1/42; G01J 1/44

(52) U.S. Cl. CPC G01J 1/4204; G01J 1/44; G01J 2001/4466

(57) ABSTRACT

According to an embodiment, a system for ambient light sensing includes a single-photon avalanche diode (SPAD) pixel array configured to detect photons, an adder coupled to the SPAD pixel array to sum outputs representing detected photons, and a comparator that generates a signal when the adder output reaches a predetermined threshold corresponding to a percentage of the array that has detected photons. A time-to-digital converter (TDC) measures periods between consecutive comparator signals, and a feedback path from the comparator to the SPAD pixel array resets the array when the threshold is reached. The measured periods inversely correlate with ambient light intensity.

### TECHNICAL FIELD

The present disclosure generally relates to electronic devices and, in particular embodiments, to a single-photon avalanche diode system for ambient light sensing.

### BACKGROUND

Single-photon avalanche diodes (SPADs) have emerged as highly sensitive photodetectors capable of detecting individual photons with precise timing resolution. These semiconductor devices operate in Geiger mode, biased above their breakdown voltage, allowing a single photon to trigger an avalanche of charge carriers. The resulting current pulse can be detected and processed by associated circuitry. SPADs offer high sensitivity, fast response times, and compatibility with standard semiconductor manufacturing processes.

Ambient light sensing (ALS) represents an important application area for photosensitive technologies. ALS systems measure the intensity of surrounding light to enable automatic display brightness adjustment in consumer electronic devices such as smartphones and tablets. These systems help optimize screen visibility across varying lighting conditions while conserving battery power. Additionally, ALS data may contribute to color correction in photography applications by providing information about the spectral characteristics of ambient illumination.

Traditional photodiode-based ALS systems measure light intensity through analog current integration. As light strikes a photodiode, electron-hole pairs generate a current proportional to the incident light intensity. This current can be integrated over time to produce a voltage that correlates with the ambient light level. However, these analog approaches may face challenges in very low-light conditions, where the signal-to-noise ratio becomes problematic.

Time-based measurement techniques offer an alternative approach to light intensity detection. Rather than measuring current or charge directly, these methods quantify the temporal characteristics of photon arrivals. For random photon arrivals from ambient light sources, the time intervals between consecutive photon detections follow an exponential distribution. The mean of this distribution relates inversely to the photon arrival rate, which correlates with light intensity. Time-to-digital converters (TDCs) can measure these intervals with high precision.

Large-area photon detection can enhance sensitivity in light-sensing applications. Increasing the photosensitive area allows more photons to be captured, improving the signal-to-noise ratio, particularly in low-light conditions. However, scaling photon detection across larger areas can present signal routing, power distribution, and readout architecture challenges. Various approaches to combining signals from multiple photosensitive elements may include logical OR combinations, adder networks, or other aggregation methods.

Power consumption is another consideration for portable electronic devices. Circuits requiring high-frequency clocking or distributing signals across large chip areas can consume substantial power. Power efficiency directly impacts battery life and user experience in battery-powered devices such as smartphones. Techniques that reduce clocking requirements or adapt system operation to current conditions can help minimize power consumption while maintaining performance.

### SUMMARY

Technical advantages are generally achieved by embodiments of this disclosure, which describe a single-photon avalanche diode system for ambient light sensing.

A first aspect relates to a system for ambient light sensing, comprising a single-photon avalanche diode (SPAD) pixel array configured to detect photons; an adder coupled to the SPAD pixel array, the adder configured to sum outputs from the SPAD pixel array to generate a digital output representing a number of SPAD pixels that have detected photons; a comparator coupled to the adder, the comparator configured to generate a signal in response to the digital output from the adder reaching a predetermined threshold corresponding to a percentage of the SPAD pixel array that has detected photons; a time-to-digital converter (TDC) coupled to the comparator, the TDC configured to measure a period between consecutive signals from the comparator; and a feedback path from the comparator to the SPAD pixel array, the feedback path configured to reset the SPAD pixel array in response to the predetermined threshold being reached, wherein the measured period determines ambient light intensity.

A second aspect relates to a system for ambient light sensing, comprising a single-photon avalanche diode (SPAD) pixel array configured to detect photons; a controller configured to generate an enable signal; a plurality of transistors, each transistor having a gate terminal coupled to the controller to receive the enable signal, wherein each transistor is coupled to a respective SPAD pixel in the SPAD pixel array; an adder coupled to the SPAD pixel array, the adder configured to sum outputs from the SPAD pixel array to generate a digital output representing a number of SPAD pixels that have detected photons; a comparator coupled to the adder, the comparator configured to generate a comparator signal in response to the digital output from the adder reaching a predetermined threshold corresponding to a percentage of the SPAD pixel array that has detected photons; and a time-to-digital converter (TDC) coupled to the controller and the comparator, the TDC configured to measure a period between the enable signal and the comparator signal, wherein the measured period determines ambient light intensity.

A third aspect relates to a method for ambient light sensing, comprising detecting photons by a single-photon avalanche diode (SPAD) pixel array; summing outputs from the SPAD pixel array to generate a digital output representing a number of SPAD pixels that have detected photons; comparing the digital output to a predetermined threshold corresponding to a percentage of the SPAD pixel array; generating a signal in response to the digital output reaching the predetermined threshold; measuring a period related to the signal; and determining ambient light intensity based on the measured period.

Embodiments can be implemented in hardware, software, or any combination thereof.

### BRIEF DESCRIPTION OF THE DRAWINGS

For a more complete understanding of the present disclosure and the advantages thereof, reference is now made to the following descriptions taken in conjunction with the accompanying drawings, in which:

FIG. 1A is a block diagram of a circuit for measuring ambient using a Single-Photon Avalanche Diode (SPAD) based system;

FIG. 1B shows a series of timing diagrams demonstrating the operating principles of the circuit in FIG. 1A;

FIG. 2A is a block diagram of a circuit for measuring ambient light using an alternative SPAD-based system;

FIG. 2B shows a series of timing diagrams that demonstrate the operating principles of the circuit in FIG. 2A;

FIG. 3A is a block diagram of a circuit for measuring ambient light using multiple SPAD pixels through an OR gate;

FIG. 3B shows a series of timing diagrams that demonstrate the operating principles of the circuit shown in FIG. 3A;

FIG. 4A is a block diagram of a circuit for measuring ambient light using multiple SPAD pixels combined through an adder;

FIG. 4B shows a series of timing diagrams demonstrating the operating principles of the circuit in FIG. 4A;

FIG. 5 is a block diagram of a circuit for measuring ambient light using a threshold-based approach with multiple SPAD pixels;

FIG. 6 is an example of operation using a timing diagram concerning the circuit shown in FIG. 5;

FIG. 7 is a block diagram of a circuit for measuring ambient light using a self-clocked threshold-based approach with multiple SPAD pixels;

FIG. 8 is an example operation of a timing diagram concerning the self-clocked circuit shown in FIG. 7;

FIG. 9 is a block diagram of a controller that may be used to implement control functions for the ambient light sensing systems;

FIG. 10 is a flowchart of a method for ambient light sensing using a SPAD-based system; and

FIG. 11 is a block diagram of a device that incorporates the ambient light sensing technology described in previous embodiments.

### DETAILED DESCRIPTION OF ILLUSTRATIVE EMBODIMENTS

This disclosure provides many applicable inventive concepts that can be embodied in a wide variety of specific contexts. The particular embodiments are merely illustrative of specific configurations and do not limit the scope of the claimed embodiments. Features from different embodiments may be combined to form further embodiments unless noted otherwise. Various embodiments are illustrated in the accompanying drawing figures, where identical components and elements are identified by the same reference number, and repetitive descriptions are omitted for brevity.

Variations or modifications described in one of the embodiments may also apply to others. Further, various changes, substitutions, and alterations can be made herein without departing from the spirit and scope of this disclosure as defined by the appended claims.

While the aspects described in this disclosure are presented primarily in the context of ambient light sensing for consumer handheld devices, it should also be appreciated that these aspects may also apply to other photon detection applications. In particular, aspects of this disclosure may similarly apply to proximity sensing, gesture recognition systems, biomedical imaging, scientific instrumentation, automotive sensing, security systems, and industrial automation, where photon counting and timing can provide valuable measurement capabilities. The techniques for efficient photon detection using SPAD arrays may extend to applications requiring low-power operation, high sensitivity, or adaptive measurement timing across varying light conditions.

Embodiments of the disclosure provide systems and methods for ambient light sensing using Single-Photon Avalanche Diode (SPAD) technology. The described approaches may be particularly suitable for consumer electronic devices such as smartphones, where power efficiency and accurate light measurement are desirable.

The disclosed systems utilize a SPAD pixel array for detecting photons across a relatively large sensing area. Rather than requiring individual Time-to-Digital Converters (TDCs) for each SPAD pixel, embodiments of the disclosure employ an adder coupled to multiple SPAD pixels. The adder sums the outputs from the SPAD pixels to generate a digital value representing how many pixels have detected photons at any given moment.

In embodiments, a comparator monitors the adder output and generates a signal when a predetermined threshold is reached, indicating that a specific percentage of the SPAD array has detected photons. A time-to-digital converter (TDC) can measure the time between an initial enable signal and the comparator output signal. The measured time correlates with ambient light intensity-shorter times indicate higher light levels, while longer times suggest lower light levels.

In some embodiments, a feedback path from the comparator to the SPAD pixel array creates a self-clocked architecture. When the comparator detects the threshold percentage of pixels has fired, the feedback signal resets the SPAD array to begin a new measurement cycle. The TDC measures the time between consecutive reset signals, which provides information about the ambient light level without requiring external clocking.

The described approaches offer several advantages over conventional solutions. Power consumption may be reduced by localizing high-speed timing to the TDC block rather than distributing fast clock signals across the entire SPAD array. The recharge signal rate to the SPADs can be decreased, saving power in the clocking networks that span the full array. Additionally, the system can adapt to different light conditions without requiring an initial scanning process to determine appropriate timing parameters.

The system can collect measurements more quickly for high light conditions since the threshold will be reached in less time. The system avoids unnecessary recharge cycles in low light conditions when photon arrivals are infrequent. The self-clocked version improves efficiency by automatically adjusting to the ideal exposure window for any light level. These and additional details are further discussed below.

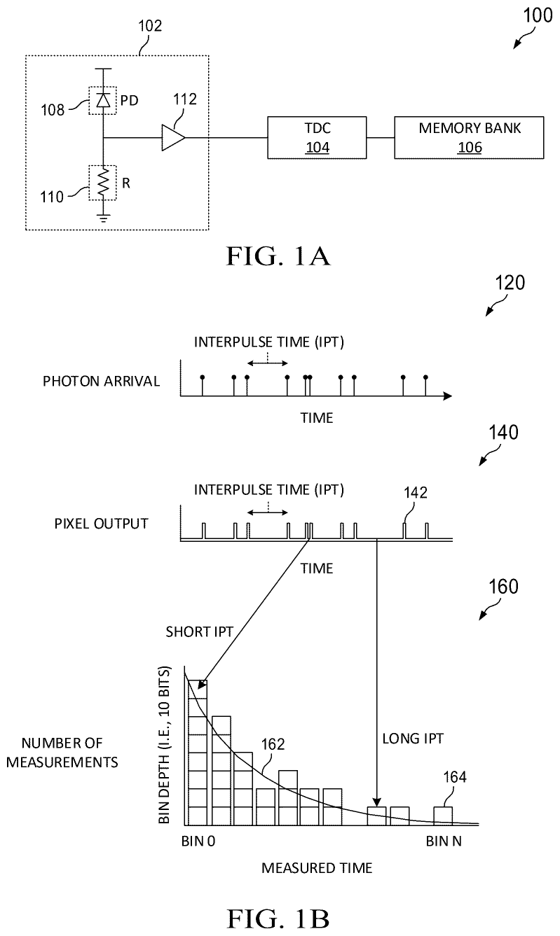

FIG. 1A illustrates a block diagram of a circuit 100 for measuring ambient using a Single-Photon Avalanche Diode (SPAD) based system. Circuit 100 includes a SPAD pixel 102, a Time-to-Digital Converter (TDC) 104, and a memory bank 106, which may (or may not) be arranged as shown. Circuit 100 may include additional components not shown.

SPAD pixel 102 includes a photodiode (PD) 108 that detects individual photons, a resistor (R) 110 for biasing the photodiode, and a buffer/amplifier 112 that conditions and amplifies the signal before sending it to the TDC 104. This configuration represents a basic single-pixel implementation of a SPAD-based ambient light sensor. The TDC 104 measures time intervals between photon detection events, and the memory bank 106 stores these measurements.

In some configurations, the memory bank 106 can be replaced with an accumulator that includes an adder and memory without forming a complete histogram. In such implementations, the TDC output is provided to the adder of the accumulator, the output of the adder is provided to memory, and the memory output is fed back to the adder. This approach calculates the mean interpulse time without storing the full histogram distribution.

In these implementations, the SPAD pixel 102 operates free-running without an external clock signal controlling its operation. However, the TDC 104 may utilize a reference clock for its time measurements.

FIG. 1B shows a series of timing diagrams demonstrating the operating principles of circuit 100. The figure includes a first diagram 120, a second diagram 140, and a third diagram 160.

The first diagram 120 depicts photon arrival events over time, where each vertical line represents a discrete photon striking the SPAD pixel 102. These arrivals follow a random Poisson process characteristic of ambient light. The interpulse time (IPT) corresponds to the interval between consecutive photon arrivals, which can vary based on light intensity.

The second diagram 140 illustrates the corresponding pixel output 142 generated by the SPAD pixel 102 provided to the input of the TDC 104. Each rectangular pulse represents the digital signal produced when the SPAD detects a photon—the TDC 104 measures the time intervals between these pulses (interpulse time).

The third diagram 160 displays the histogram representation of the accumulated interpulse time measurements stored in the memory bank 106. The x-axis shows measured time from Bin o (shortest times) to Bin N (longest times), while the y-axis indicates the number of measurements at each time interval with a bin depth of 10 bits. The histogram approximates an exponential distribution, as shown by the probability density function curve 162. Short IPTs are identified on the left side of the histogram and are more likely to occur in bright light conditions, while long IPTs appear on the right side and are more likely to occur in lower light levels. Each rectangular box 164 of the various binning's represents a single TDC measurement stored in the memory bank 106. The mean value of this histogram corresponds to the average interpulse time, which inversely correlates with ambient light intensity.

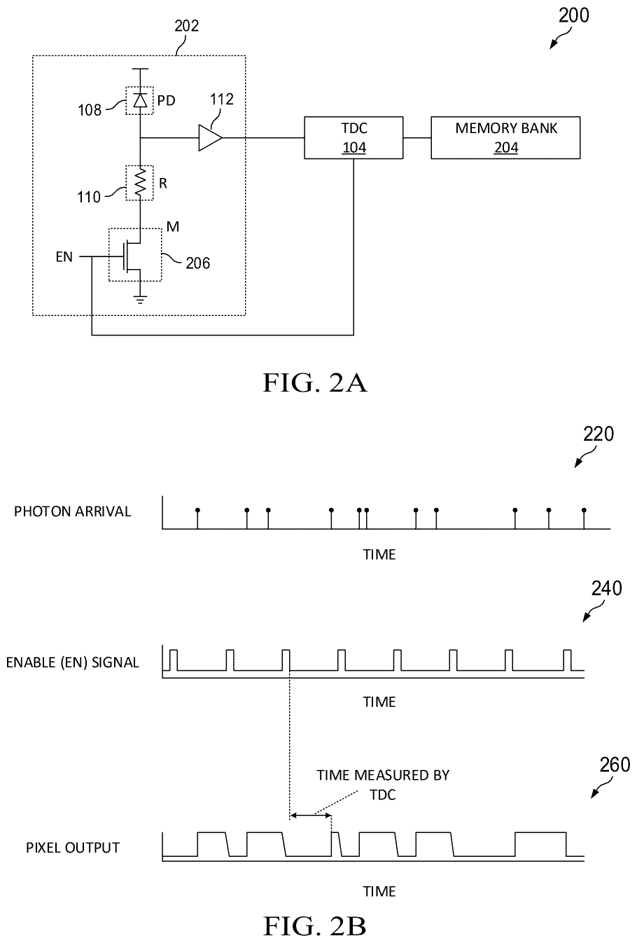

FIG. 2A illustrates a block diagram of a circuit 200 for measuring ambient light using an alternative SPAD-based system. Circuit 200 includes a SPAD pixel 202, a Time-to-Digital Converter (TDC) 104, and memory banks 204, which may (or may not) be arranged as shown. Circuit 200 may include additional components that are not shown, such as a controller coupled to the SPAD pixel 202 and the TDC 104, to generate an enable (EN) signal.

SPAD pixel 202 includes a photodiode (PD) 108 that detects individual photons, a resistor (R) 110 for biasing the photodiode, a buffer/amplifier 112 that conditions and amplifies the signal, and a transistor (M) 206 that functions as a control gate. The transistor 206 receives the enable (EN) signal that controls when the SPAD pixel 202 is active. The same enable signal is also provided to the TDC 104, creating a reference point for time measurements.

In this configuration, the SPAD pixel 202 and the TDC 104 are triggered using the common enable control signal. When a photon is detected, the TDC 104 measures the delay between the enable signal and the pixel output from the SPAD pixel 202. The delay measurements are stored in the memory bank 204, which can be implemented as a 32 by 10-bit memory bank. In some configurations, the memory bank 204 can be replaced with a single accumulator memory to find the mean of the histogram, which represents the value of interest for the ambient light sensing application.

The enable signal can be generated by a controller (not shown). This controller is configured to produce periodic enable pulses that activate the SPAD pixel 202 through the transistor 206 and simultaneously provide a reference timing signal to the TDC 104. The controller can be implemented as a digital circuit that generates precisely timed enable pulses at intervals appropriate for the ambient light sensing application.

FIG. 2B shows a series of timing diagrams that demonstrate the operating principles of circuit 200. The figure includes a first diagram 220, a second diagram 240, and a third diagram 260.

The first diagram, 220, depicts photon arrival events over time. Each vertical line represents a discrete photon striking the SPAD pixel 202. These arrivals follow a random Poisson process characteristic of ambient light.

The second diagram 240 illustrates the enable (EN) signal that controls the SPAD pixel 202 and provides a reference for the TDC 104. The enable signal activates the SPAD pixel 202 through transistor 206 in periodic pulses.

The third diagram 260 shows the pixel output generated by the SPAD pixel 202 in response to photon detections when enabled. The TDC 104 measures the time between the enable signal's falling edge and the pixel output's rising edge when a photon is detected. The measurement approach differs from the interpulse time measurement shown in FIG. 1B, as it measures the delay from enabling the pixel to photon detection rather than the time between consecutive photon detections.

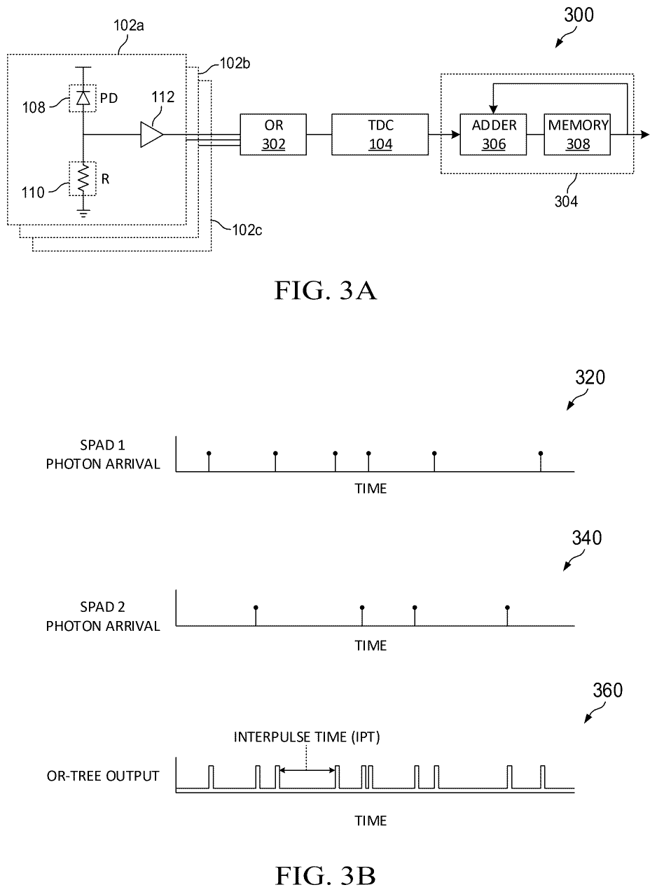

FIG. 3A illustrates a block diagram of a circuit 300 for measuring ambient light using multiple SPAD pixels through an OR gate. Circuit 300 includes multiple SPAD pixels 102a-c, an OR gate 302, a Time-to-Digital Converter (TDC) 104, and an accumulator 304 comprising an adder 306 coupled to memory 308. While three SPAD pixels (102a-c) are shown in the figure, this number is non-limiting, and embodiments with a greater number of SPAD pixels are contemplated.

Each SPAD pixel 102a-c includes a photodiode (PD) 108, a resistor (R) 110, and a buffer/amplifier 112, similar to the SPAD pixel 102 of FIG. 1A. The outputs from multiple SPAD pixels are combined using an OR gate 302, producing a logical high output whenever any connected SPAD pixels detect a photon. This approach allows sharing a TDC 104 and accumulator 304 across multiple SPAD pixels rather than replicating the complete circuit for each SPAD pixel.

The TDC 104 measures the interpulse time (IPT) between consecutive pulses from the OR gate 302 output. These measurements are provided to the accumulator 304, where the adder 306 combines the current measurement with the accumulated value stored in memory 308, and the result is stored back in memory 308. This accumulation approach allows calculating the mean interpulse time without storing a complete histogram.

FIG. 3B shows a series of timing diagrams that demonstrate the operating principles of the circuit shown in FIG. 3A. The figure includes a first diagram 320, a second diagram 340, and a third diagram 360.

The first diagram 320 depicts photon arrival events over time for a first SPAD pixel (SPAD 1), where each vertical line represents a discrete photon detection event.

The second diagram 340 illustrates photon arrival events over time for a second SPAD pixel (SPAD 2), showing a different pattern of photon detections.

The third diagram 360 shows the OR-tree output from combining the signals from multiple SPAD pixels 102a-c through the OR gate 302. Each pulse represents a photon detection from any of the connected SPAD pixels 102a-c. The TDC 104 measures the interpulse time (IPT) between consecutive pulses, as indicated in the third diagram 360.

While this OR-tree approach allows for sharing the TDC 104 and accumulator 304 resources across multiple SPAD pixels 102a-c, it can suffer from disadvantages when the event rate is high. In particular, when multiple photons arrive nearly simultaneously at different SPAD pixels, the OR gate may not be able to resolve them as separate events, leading to a phenomenon known as “pile-up,” where photon detection events are missed or merged. This limitation becomes more pronounced as the number of SPAD pixels or the ambient light level increases.

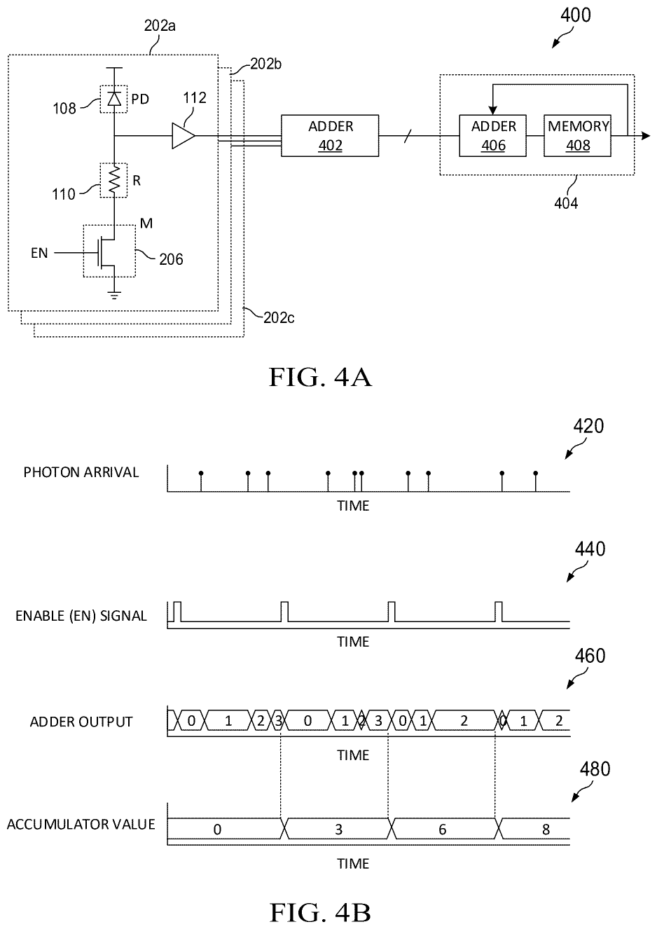

FIG. 4A illustrates a block diagram of a circuit 400 for measuring ambient light using multiple SPAD pixels combined through an adder. Circuit 400 includes multiple SPAD pixels 202a-c, an adder 402, and an accumulator 404 comprising an adder 406 coupled to memory 408. While three SPAD pixels (202a-c) are shown in the figure, this number is non-limiting, and embodiments with a greater number of SPAD pixels are contemplated.

Each SPAD pixel 202a-c includes a photodiode (PD) 108, a resistor (R) 110, a buffer/amplifier 112, and a transistor (M) 206 that functions as a control gate. The transistor 206 receives an enable (EN) signal that controls when the SPAD pixels are active. Unlike the OR gate approach shown in FIG. 3A, the outputs from multiple SPAD pixels 202a-c are combined using an adder 402, which produces a digital value representing the number of SPAD pixels that have detected photons during each enable period.

The output of adder 402 is provided to the accumulator 404, where adder 406 combines the current count with the accumulated value stored in memory 408, and the result is stored back in memory 408. This approach avoids the pile-up issues associated with the OR-tree method by explicitly counting the number of pixels that have detected at least one photon.

Unlike previous configurations, circuit 400 does not include a Time-to-Digital Converter (TDC). Instead of measuring time intervals between photon detections or between an enable signal and photon detections, this approach directly counts the number of SPAD pixels that detect photons during each enable period.

By removing the TDC and focusing on counting photon detections across multiple SPAD pixels, circuit 400 simplifies the measurement approach while potentially reducing power consumption and circuit complexity. This configuration can be particularly suitable for ambient light sensing applications where the total photon count across an array of SPAD pixels provides sufficient information about light intensity without requiring precise timing measurements.

FIG. 4B shows a series of timing diagrams demonstrating the operating principles of circuit 400. The figure includes a first diagram 420, a second diagram 440, a third diagram 460, and a fourth diagram 480.

The first diagram 420 depicts photon arrival events over time, where each vertical line represents a discrete photon striking one of the SPAD pixels 202a-c.

The second diagram 440 illustrates the enable (EN) signal that controls the SPAD pixels 202a-c through their respective transistors 206. Precise control over the enable signal is necessary to perform accurate ambient light sensing measurements using this method.

The third diagram 460 shows the adder output generated by adder 402, which represents the number of SPAD pixels that detected photons during each enable period. The values (0, 1, 2, 3) indicate how many SPAD pixels detected photons during each sampling interval.

The fourth diagram 480 displays the accumulator value stored in memory 408, which increases over time as the adder 406 combines the current adder output with the previously accumulated value. The accumulator value starts at zero and increases to three, then six, and finally eight as more photon detections are counted. This accumulated value can be used to determine the ambient light level based on the number of sampling periods and their duration.

This adder-based approach provides advantages over the OR-tree method shown in FIG. 3A by accurately counting the number of pixels that have had successful photon detections, thereby avoiding the pile-up limitations that occur at high photon rates.

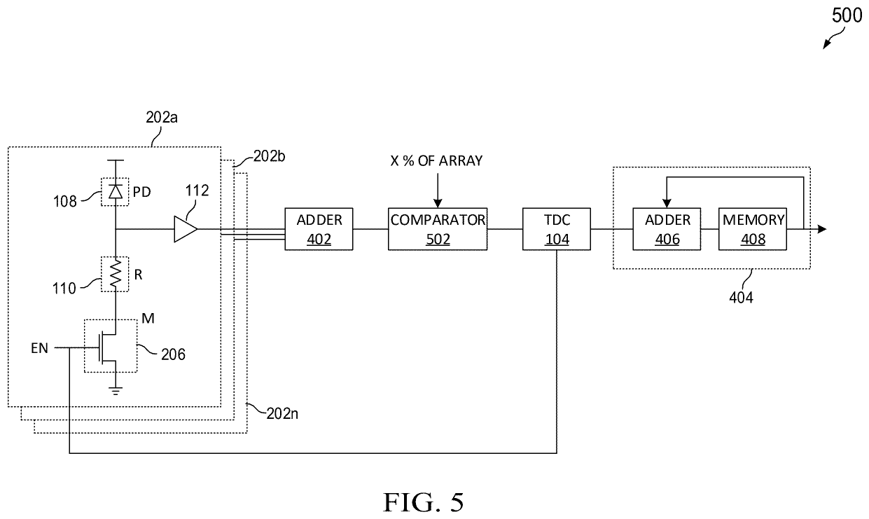

FIG. 5 illustrates a block diagram of a circuit 500 for measuring ambient light using a threshold-based approach with multiple SPAD pixels, according to an embodiment of this disclosure. Circuit 500 includes multiple SPAD pixels 202a-202n, an adder 402, a comparator 502, a Time-to-Digital Converter (TDC) 104, and an accumulator 404 comprising an adder 406 coupled to memory 408, which may (or may not) be arranged as shown. Circuit 500 may include additional components not shown, such as a controller coupled to the gate terminal of the transistor 206 of each SPAD pixel 202a-n and the TDC 104.

While the figure shows SPAD pixels labeled from 202a to 202N, this representation indicates that the system may include a large number of SPAD pixels in the array. For example, the number of SPAD pixels can be 100 or greater in some implementations.

Each SPAD pixel 202A-N includes a photodiode (PD) 108, a resistor (R) 110, a buffer/amplifier 112, and a transistor (M) 206 that functions as a control gate. The transistor 206 receives an enable (EN) signal that controls when the SPAD pixels 202a-n are active. The outputs from all SPAD pixels 202a-n are combined using adder 402, which produces a digital value representing the number of SPAD pixels that have detected photons.

Each SPAD pixel 202a-n in the array includes a dedicated recharge input controlled by the enable (EN) signal. When a photon is detected, a SPAD pixel generates a binary output (1 for detection, 0 for no detection). These binary outputs from all SPAD pixels are summed by adder 402 to produce a digital value representing the percentage of the array that has detected photons. As more photons arrive over time after the array is enabled, this percentage monotonically increases until it reaches the threshold value set in comparator 502.

The output of adder 402 is provided to comparator 502, which compares the adder output against a threshold value representing X percent of the SPAD array. When the adder output reaches this threshold, indicating that X percent of the SPAD pixels 202a-n have detected photons, the comparator 502 generates a signal sent to the TDC 104. The TDC 104 measures the time between the enable signal and the comparator output, representing the time taken for X percent of the array to detect photons.

The predetermined threshold percentage (X %) used by the comparator 502 represents a parameter that can be optimized to balance measurement accuracy against measurement time. When set to a lower percentage (e.g., 10-20% of the SPAD array), the threshold will be reached more quickly, resulting in faster measurements but potentially with reduced statistical accuracy. This configuration may be advantageous in high light conditions or when power consumption and measurement speed are prioritized over precision. Conversely, when set to a higher percentage (e.g., 70-90% of the SPAD array), more photons must be detected before the measurement completes, resulting in longer measurement times but improved statistical accuracy. This configuration may be preferred in applications requiring high precision or in moderate light conditions.

The optimal threshold percentage may vary depending on the specific application requirements and ambient light conditions. For example, in very low light environments, a lower threshold percentage may be necessary to ensure measurements complete within a reasonable timeframe, while accepting some reduction in accuracy. In controlled lighting environments, a higher threshold can be used to maximize measurement precision. The threshold can be programmatically adjusted by the controller 900 based on recent measurement history, allowing the system to adapt to changing environmental conditions. This parameter thus provides system designers with a flexible means to optimize the performance characteristics most important for their specific implementation.

The enable (EN) signal for circuit 500 is generated by a controller (not shown) that is coupled to each transistor 206 of the SPAD pixels 202a-202N and the TDC 104. This controller is responsible for producing precisely timed enable pulses that simultaneously activate all SPAD pixels in the array and provide a reference timing signal to the TDC 104. The controller may be implemented as a digital circuit that generates enable signals at intervals appropriate for ambient light sensing applications. By providing a common enable signal to all SPAD pixels and the TDC, the system establishes a synchronized starting point for each measurement cycle. This allows accurate timing of how long it takes for X percent of the array to detect photons.

The TDC 104 output is provided to accumulator 404, where adder 406 combines the current time measurement with the accumulated value stored in memory 408. The result is stored back in memory 408. This accumulated time value can be used to determine the ambient light level.

This approach represents a shift in the TDC measurement technique. Rather than measuring the time between consecutive photon detections (interpulse time) or the time for a single photon to be detected, the system measures the time required for a specific percentage of the SPAD array to detect photons. The statistical distribution of this measurement follows a Gamma distribution, which is a generalization of the exponential distribution seen in single-photon detection timing.

The adder output in this system monotonically increases over time following the cumulative distribution function (CDF) of an exponential distribution, which can be expressed as 1−e^{-λt}, where λ represents the event rate (i.e., photon arrival rate) and t is time. This function describes the probability that a single SPAD will detect a photon within time t.

When considering the time required for multiple events (X percent of the array detecting photons), the statistical model shifts to a Gamma distribution. The Gamma distribution can be expressed as

$$P ( t , k ) = \frac{{λ}^{k} {t}^{k - 1} {e}^{- λ t}}{( k - 1 ) !} ,$$

where k represents the number of events (corresponding to X percent of the array). This distribution predicts the time before k events occur, given an event rate λ, and provides the mathematical foundation for extracting the ambient light level from the measured time values.

Circuit 500 offers several advantages over previous approaches. Advantageously, power consumption is reduced by localizing high-speed timing to the TDC 104, outside of the SPAD array. The recharge signal rate to the SPADs is also reduced, saving power in the clocking networks that span the full array. Additionally, the proposed approach provides more efficient photon utilization since the measurement automatically adapts to the photon rate, preventing saturation issues that can occur with fixed-window approaches.

The threshold percentage (i.e., X percent of the SPAD array) can be tuned to optimize the accuracy of the measurement versus collection time. This parameter allows the system to balance collecting sufficient statistical data for an accurate measurement and completing the measurement quickly, particularly in varying light conditions.

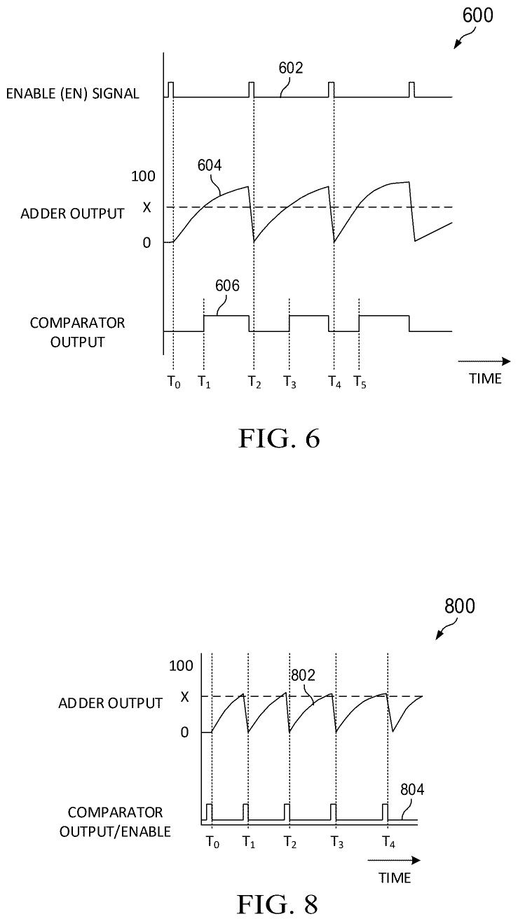

FIG. 6 illustrates an example of operation using a timing diagram 600 concerning circuit 500, shown in FIG. 5. Timing diagram 600 depicts the timing relationships between signals in the system. The figure includes three timing diagrams: an enable signal 602, an adder output 604, and a comparator output 606.

The enable (EN) signal 602 controls when the SPAD pixels are active. Each falling edge of the enable signal (at times Tₒ, T₂, and T₄) initiates a new measurement cycle by resetting and activating the SPAD array.

The adder output 604 represents the percentage of SPAD pixels that have detected photons over time. The adder output starts at zero at the beginning of each enable cycle and increases monotonically as more SPAD pixels detect photons. The horizontal dashed line represents the comparator threshold, which is set to a specific percentage of the total SPAD array (for example, 50% of the array). The adder output follows a curve that approximates the cumulative distribution function of an exponential distribution, with the rate of increase corresponding to the ambient light level.

An advantage of the self-clocked approach in circuit 700 is the elimination of the need to scan through different exposure window durations to find the optimal setting. In conventional externally-clocked systems like circuit 500, the controller must initially determine the appropriate exposure window duration based on the expected ambient light level. This typically requires a calibration phase where the system tests multiple exposure durations-short windows for potentially bright conditions and longer windows for potentially dim conditions-until it finds a suitable setting that produces reliable measurements.

The self-clocked architecture inherently eliminates this scanning process. Since the system automatically resets as soon as the threshold percentage of SPAD pixels has detected photons, it naturally adapts to the current light level without prior knowledge or calibration. In bright conditions, the threshold is reached quickly, resulting in short measurement cycles, while in dim conditions, the system naturally extends the integration time until sufficient photons are detected. This adaptive behavior occurs from the first measurement cycle without requiring preliminary exposure window calibration. The result is a faster overall system response to changing light conditions, reduced computational overhead in the controller, and more efficient operation across the entire range of possible ambient light levels.

The comparator output 606 transitions from low to high when the adder output reaches the threshold value X. The comparator output remains high until the next enable cycle resets the system (here, the transition corresponds to the rising edge of the enable signal 602). The time intervals between the rising edge of the enable signal and the rising edge of the comparator output (T₁−Tₒ, T₃−T₂, and T₅−T₄) represent the time measurements captured by the TDC 104.

These time measurements are inversely related to the ambient light level. In brighter conditions, the adder output reaches threshold X more quickly, resulting in shorter time intervals. Conversely, in dimmer conditions, it takes longer for enough SPAD pixels to detect photons, resulting in longer time intervals. The system can accurately determine the ambient light level by accumulating and analyzing these time measurements.

The figure demonstrates how the system automatically adapts to different light conditions without requiring adjustment of the enable signal timing. The measurement completes as soon as the required percentage of the array has detected photons, optimizing measurement time and power consumption across varying ambient light levels.

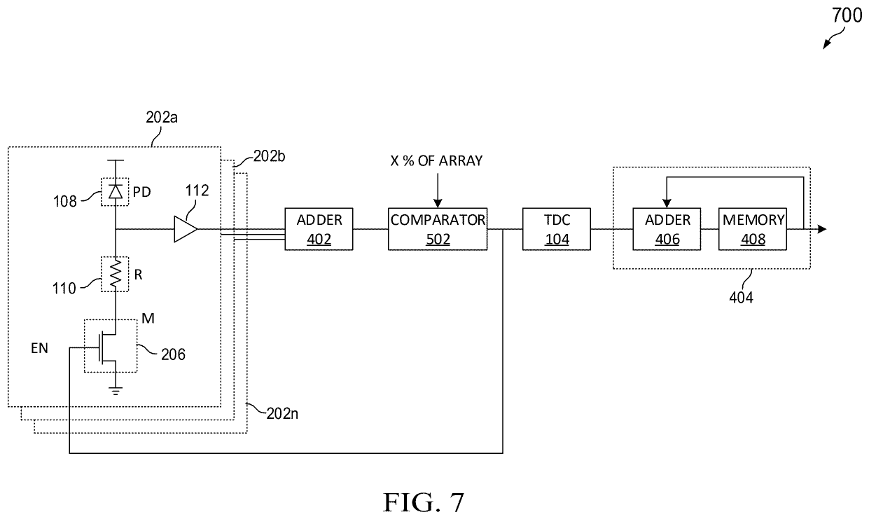

FIG. 7 illustrates a block diagram of a circuit 700 for measuring ambient light using a self-clocked threshold-based approach with multiple SPAD pixels, according to an embodiment of the disclosure. Circuit 700 includes multiple SPAD pixels 202a-202n, an adder 402, a comparator 502, a Time-to-Digital Converter (TDC) 104, and an accumulator 404 comprising an adder 406 coupled to memory 408, which may (or may not) be arranged as shown.

A distinction between circuit 700 and circuit 500 in FIG. 5 is the feedback path from the comparator 502 output to the gate terminal of each transistor 206 in the SPAD pixels 202a-202n. This feedback connection creates a self-clocked system where the pixel array doesn't need to be explicitly enabled with a periodic signal from an external controller. Instead, the pixel array is automatically reset when the comparator output has flipped, indicating that X percent of the array has detected photons.

In this self-clocked configuration, the TDC 104 measures the time between consecutive comparator output transitions rather than between an external enable signal and the comparator output. When the comparator 502 detects that X percent of the SPAD pixels have fired, its output signal triggers the TDC 104 to record the time measurement and resets the SPAD array to begin a new exposure window.

An advantage of the self-clocked approach in circuit 700 is eliminating the need to scan through different exposure window durations to find the optimal setting. In conventional externally-clocked systems like circuit 500, the controller must initially determine the appropriate exposure window duration based on the expected ambient light level. This typically requires a calibration phase where the system tests multiple exposure durations-short windows for potentially bright conditions and longer windows for potentially dim conditions-until it finds a suitable setting that produces reliable measurements.

Advantageously, the self-clocked architecture inherently eliminates this scanning process. Since the system automatically resets as soon as the threshold percentage of SPAD pixels has detected photons, it naturally adapts to the current light level without prior knowledge or calibration. In bright conditions, the threshold is reached quickly, resulting in short measurement cycles, while in dim conditions, the system naturally extends the integration time until sufficient photons are detected. This adaptive behavior occurs from the first measurement cycle without requiring preliminary exposure window calibration.

Further, circuit 700 reduces power consumption and system complexity by eliminating the need for an external controller to generate periodic enable signals. The measurement cycle time is optimized for each light condition, improving efficiency in bright environments (where measurements complete quickly) and low-light environments (where the system naturally extends the integration time without wasting power on unnecessary recharge cycles).

FIG. 8 illustrates an example operation of a timing diagram 800 concerning the self-clocked circuit 700 shown in FIG. 7. Timing diagram 800 shows the timing relationships between signals in the system. The figure includes an adder output 802 and a comparator output/enable signal 804.

The adder output 802 represents the percentage of SPAD pixels that have detected photons over time. The adder output starts at zero at the beginning of each measurement cycle (i.e., following each reset) and increases monotonically, along a curved trajectory toward the specific percentage (X) of the total SPAD array, as more SPAD pixels detect photons. The horizontal dashed line represents the comparator threshold, which is set to the specific percentage (X) of the total SPAD array (for example, 50% of the array). The curve follows a pattern that approximates the cumulative distribution function of an exponential distribution, with the rate of increase corresponding to the ambient light level. The adder output 802 rises until it precisely intersects with the threshold value X, at which point the comparator triggers.

When the adder output 802 reaches the threshold value X, the comparator output/enable signal 804 transitions from low to high. This transition triggers the TDC 104 to record a time measurement and resets all SPAD pixels in the array. This reset causes the adder output to drop to zero, beginning a new measurement cycle. The timing diagram 800 shows this pattern repeating across multiple measurement cycles (Tₒ through T₄).

The time intervals between consecutive time points (T₁−Tₒ, T₂−T₁, T₃−T₂, and T₄−T₃) represent the periods measured by the TDC 104. These measurements directly correlate with ambient light levels-shorter intervals indicate higher light levels, while longer intervals suggest lower light levels.

Unlike externally-clocked systems, the self-clocked operation shown in FIG. 8 demonstrates how the circuit automatically adapts its measurement cycle duration based on current light conditions without requiring external control signals. Each measurement cycle completes when the threshold percentage of pixels has detected photons, creating a self-regulating system.

In embodiments, the adaptive nature of the measurement cycles in the self-clocked configuration provides an advantage in preventing saturation issues that can occur in fixed-window approaches. In conventional systems with predetermined measurement windows, bright light conditions may cause the system to saturate if too many photons arrive during the fixed window, leading to measurement inaccuracies.

The self-clocked architecture in circuit 700 inherently prevents this problem by automatically shortening the measurement cycle when photon arrivals are frequent. As soon as the threshold percentage of SPAD pixels has detected photons, the system resets and begins a new cycle, ensuring that measurements remain accurate across the entire range of possible light conditions from very bright to very dim environments. This adaptive approach maintains optimal signal-to-noise ratio without requiring complex gain control mechanisms that would otherwise be necessary in fixed-window systems.

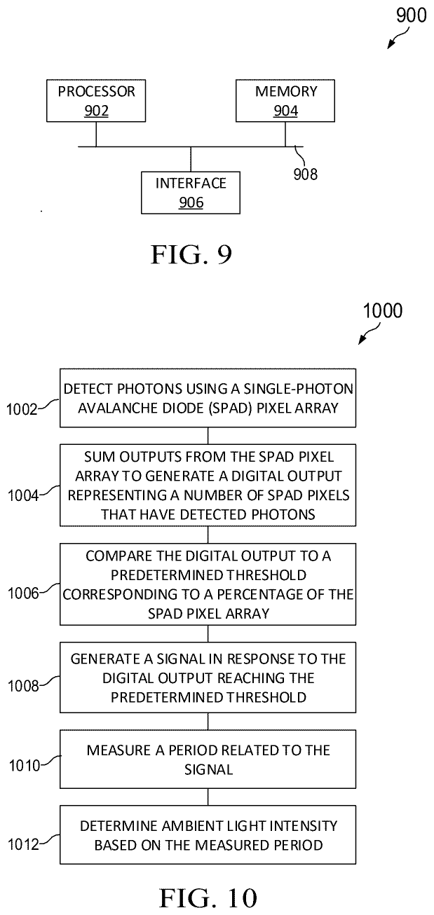

FIG. 9 illustrates a block diagram of a controller 900 that may be used to implement control functions for the ambient light sensing systems described in previous figures, according to an embodiment of the disclosure. Controller 900 includes a processor 902, memory 904, and an interface 906, all coupled via a bus 908.

In embodiments where external control of the SPAD array is required, such as in circuit 500 shown in FIG. 5, controller 900 generates the enable (EN) signal that activates the SPAD pixels and provides a reference timing signal to the TDC. Processor 902 executes instructions stored in memory 904 to determine the appropriate timing for the enable signal based on ambient light conditions and measurement requirements. The enable signal is transmitted to the SPAD array and TDC through interface 906.

Memory 904 may store calibration data, measurement parameters (such as the threshold percentage X for the comparator), and algorithms for converting time measurements into ambient light values. It may also store historical measurement data to implement adaptive timing strategies that optimize power consumption based on recent light conditions.

Interface 906 provides communication between controller 900 and the ambient light sensing circuit components. In addition to transmitting the enable signal, interface 906 may receive measurement data from the TDC or accumulator, allowing processor 902 to calculate the final ambient light level. Interface 906 may also provide connectivity to a host system, such as a smartphone or tablet, enabling the ambient light measurements to be used for display brightness adjustment or camera settings optimization.

In self-clocked implementations such as circuit 700, as shown in FIG. 7, controller 900 may still be present but serve a different role. Rather than generating periodic enable signals, it may configure initial system parameters (such as the comparator threshold), process the accumulated time measurements to determine ambient light levels, and communicate these results to the host device. In such configurations, controller 900 operates with reduced processing requirements, further contributing to the overall system's power efficiency.

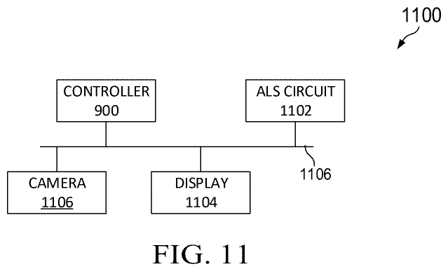

FIG. 10 illustrates a flowchart of a method 1000 for ambient light sensing using a SPAD-based system, according to an embodiment of the disclosure. Method 1000 may be implemented using either the externally-clocked circuit 500 shown in FIG. 5 or the self-clocked circuit 700 shown in FIG. 7. In various embodiments, the method may include additional or fewer steps, or the steps may be performed differently than illustrated.

At step 1002, photons are detected using a single-photon avalanche diode (SPAD) pixel array. The detection may occur in one of two ways: either by providing an enable signal from a controller to the SPAD pixel array (as in circuit 500) or by resetting the SPAD array in response to a threshold-reaching signal from a previous measurement cycle (as in circuit 700).

At step 1004, outputs from the SPAD pixel array are summed to generate a digital output representing a number of SPAD pixels that have detected photons. This digital output increases monotonically over time following a cumulative distribution function of an exponential distribution until a predetermined threshold is reached.

At step 1006, the digital output is compared to a predetermined threshold corresponding to a percentage of the SPAD pixel array. The threshold represents a specific percentage (such as 50%) of the total SPAD pixels in the array that have detected photons.

At step 1008, a signal is generated in response to the digital output reaching the predetermined threshold. This signal serves either as a measurement trigger for the TDC (in circuit 500) or as a measurement trigger and a reset signal for the SPAD array (in circuit 700).

At step 1010, a period related to the signal is measured. This measurement may be either the time interval between providing an enable signal and generating the threshold-reaching signal (for circuit 500) or the time interval between consecutive threshold-reaching signals (for circuit 700). The statistical distribution of this measured period follows a Gamma distribution.

At step 1012, ambient light intensity is determined based on the measured period.

The measured time period is inversely proportional to the ambient light intensity-shorter periods indicate higher light levels, while longer periods indicate lower ones.

Method 1000 may also include accumulating multiple measurements and calculating an average based on the accumulated measurements. This accumulation process can improve measurement accuracy by averaging out statistical variations in individual measurements.

Method 1000 provides a flexible approach to ambient light sensing that can be implemented in either an externally clocked or self-clocked configuration. The self-clocked implementation offers advantages in power efficiency and adaptive timing without requiring external control signals.

FIG. 11 illustrates a block diagram of a device 1100 that incorporates the ambient light sensing technology described in previous embodiments, according to the embodiments of this disclosure. Device 1100 includes a controller 900, an ambient light sensing (ALS) circuit 1102, a display 1104, and a camera 1108, all coupled via a bus 1106, which may (or may not) be arranged as shown. Device 1100 may include additional components not shown, such as power management circuitry, transitory and non-transitory storage, interfaces, a camera, an image processing system, and the like.

Controller 900 may be implemented as described in FIG. 9, with a processor, memory, and interface components. Alternatively, controller 900 may be implemented as the application processor of device 1100, sharing computational resources with other device functions. This integration can further reduce power consumption and component count in the overall system.

The ALS circuit 1102 may be implemented as either circuit 500 (the externally-clocked configuration shown in FIG. 5) or circuit 700 (the self-clocked configuration shown in FIG. 7). ALS circuit 1102 provides ambient light measurements to controller 900, which processes these measurements to determine the ambient light level in the device's environment.

Display 1104 represents the visual output component of device 1100, which may be adjusted based on the ambient light measurements from ALS circuit 1102. In operation, controller 900 receives ambient light measurements from ALS circuit 1102, processes these measurements, and adjusts the brightness of display 1104 accordingly. In bright ambient conditions, the display brightness is increased for better visibility, while in dim conditions, the brightness is reduced to conserve power and prevent eye strain.

Camera 1108 can utilize the ambient light information from ALS circuit 1102 to optimize various imaging parameters. For example, the controller 900 may provide the ambient light measurements to camera 1108 to assist with auto-exposure settings, allowing the camera to pre-adjust exposure times, ISO settings, or aperture values before capturing an image. Additionally, the ambient light information can help with white balance correction by providing data about the color temperature of the surrounding environment, enabling more accurate color reproduction in photographs. In video recording scenarios, the continuous ambient light measurements can help camera 1108 adapt smoothly to changing lighting conditions.

Device 1100 may be implemented in various consumer electronic products, including smartphones, tablets, laptops, smartwatches, digital cameras, or other portable devices where power efficiency, adaptive display brightness, and optimized camera performance are desirable. For example, in a smartphone implementation, the ALS circuit 1102 may be positioned near the display to accurately measure the ambient light falling on the screen, while controller 900 manages the ALS functions, camera operations, display adjustments, and other device functions.

In operation, when device 1100 is powered on, ALS circuit 1102 begins measuring ambient light using the SPAD array and threshold-based timing approach described in previous embodiments. If implemented with circuit 500, controller 900 provides periodic enable signals to the SPAD array and receives time measurements from the TDC. If implemented with circuit 700, the self-clocked configuration operates autonomously, with controller 900 receiving the processed time measurements.

Controller 900 converts these time measurements into ambient light values using the statistical relationships described earlier, where shorter measured periods indicate higher light levels. Based on these values, controller 900 adjusts the brightness of display 1104 and provides ambient light information to camera 1108 for optimized imaging.

It should be noted that while display 1104 and camera 1108 are explicitly shown as components that utilize the ambient light information from ALS circuit 1102, other components and features of device 1100 may also benefit from this information. These may include power management systems that adjust device performance based on environmental conditions, proximity sensors that use ambient light data to improve detection accuracy, user interface elements that adapt to lighting conditions, or health monitoring features that track light exposure patterns. The high sensitivity and wide dynamic range of the SPAD-based ambient light sensing approach make it valuable for numerous applications within a consumer electronic device.

A first aspect relates to a system for ambient light sensing, comprising a single-photon avalanche diode (SPAD) pixel array configured to detect photons; an adder coupled to the SPAD pixel array, the adder configured to sum outputs from the SPAD pixel array to generate a digital output representing a number of SPAD pixels that have detected photons; a comparator coupled to the adder, the comparator configured to generate a signal in response to the digital output from the adder reaching a predetermined threshold corresponding to a percentage of the SPAD pixel array that has detected photons; a time-to-digital converter (TDC) coupled to the comparator, the TDC configured to measure a period between consecutive signals from the comparator; and a feedback path from the comparator to the SPAD pixel array, the feedback path configured to reset the SPAD pixel array in response to the predetermined threshold being reached, wherein the measured period determines ambient light intensity.

In a first implementation form of the system, according to the first aspect as such, each SPAD pixel in the SPAD pixel array comprises a photodiode configured to detect photons; a resistor coupled to the photodiode; a buffer coupled to the photodiode; and a transistor coupled to the photodiode, wherein the feedback path is coupled to a gate terminal of the transistor.

In a second implementation form of the system, according to the first aspect as such or any preceding implementation form of the first aspect, the system further comprising an accumulator coupled to the TDC, the accumulator comprising a second adder configured to add time measurements from the TDC; and a memory coupled to the second adder, the memory configured to store an accumulated value of the time measurements.

In a third implementation form of the system, according to the first aspect as such or any preceding implementation form of the first aspect, the predetermined threshold is configurable to optimize a balance between measurement accuracy and measurement time.

In a fourth implementation form of the system, according to the first aspect as such or any preceding implementation form of the first aspect, the digital output of the adder increases monotonically over time following a cumulative distribution function of an exponential distribution until the predetermined threshold is reached.

In a fifth implementation form of the system, according to the first aspect as such or any preceding implementation form of the first aspect, measurement cycles automatically adjust to be shorter in bright light conditions and longer in dim light conditions, high-speed timing operations are localized to the TDC, and the system prevents saturation issues by adaptively adjusting measurement cycles based on photon detection rate.

In a sixth implementation form of the system, according to the first aspect as such or any preceding implementation form of the first aspect, the SPAD pixel array comprises at least one hundred SPAD pixels, and wherein the predetermined threshold corresponds to between 10 percent and 90 percent of the SPAD pixel array.

A second aspect relates to a system for ambient light sensing, comprising a single-photon avalanche diode (SPAD) pixel array configured to detect photons; a controller configured to generate an enable signal; a plurality of transistors, each transistor having a gate terminal coupled to the controller to receive the enable signal, wherein each transistor is coupled to a respective SPAD pixel in the SPAD pixel array; an adder coupled to the SPAD pixel array, the adder configured to sum outputs from the SPAD pixel array to generate a digital output representing a number of SPAD pixels that have detected photons; a comparator coupled to the adder, the comparator configured to generate a comparator signal in response to the digital output from the adder reaching a predetermined threshold corresponding to a percentage of the SPAD pixel array that has detected photons; and a time-to-digital converter (TDC) coupled to the controller and the comparator, the TDC configured to measure a period between the enable signal and the comparator signal, wherein the measured period determines ambient light intensity.

In a first implementation form of the system, according to the second aspect as such, each SPAD pixel in the SPAD pixel array comprises a photodiode configured to detect photons; a resistor coupled to the photodiode; and a buffer coupled to the photodiode.

In a second implementation form of the system, according to the second aspect as such or any preceding implementation form of the second aspect, the system further comprising an accumulator coupled to the TDC, the accumulator comprising a second adder configured to add time measurements from the TDC; and a memory coupled to the second adder, the memory configured to store an accumulated value of the time measurements.

In a third implementation form of the system, according to the second aspect as such or any preceding implementation form of the second aspect, the controller is configured to generate the enable signal periodically.

In a fourth implementation form of the system, according to the second aspect as such or any preceding implementation form of the second aspect, the predetermined threshold is configurable to optimize a balance between measurement accuracy and measurement time.

In a fifth implementation form of the system, according to the second aspect as such or any preceding implementation form of the second aspect, the digital output of the adder increases monotonically over time following a cumulative distribution function of an exponential distribution until the predetermined threshold is reached.

In a sixth implementation form of the system, according to the second aspect as such or any preceding implementation form of the second aspect, the controller comprises a processor; a non-transitory memory coupled to the processor; and an interface coupled to the processor and the non-transitory memory, wherein the interface is configured to provide the enable signal to the plurality of transistors and the TDC.

A third aspect relates to a method for ambient light sensing, comprising detecting photons by a single-photon avalanche diode (SPAD) pixel array; summing outputs from the SPAD pixel array to generate a digital output representing a number of SPAD pixels that have detected photons; comparing the digital output to a predetermined threshold corresponding to a percentage of the SPAD pixel array; generating a signal in response to the digital output reaching the predetermined threshold; measuring a period related to the signal; and determining ambient light intensity based on the measured period.

In a first implementation form of the method, according to the third aspect as such, detecting photons by a single-photon avalanche diode (SPAD) pixel array comprises providing an enable signal from a controller to the SPAD pixel array, and wherein measuring the period comprises measuring a time interval between providing the enable signal and generating the signal in response to the digital output reaching the predetermined threshold.

In a second implementation form of the method, according to the third aspect as such or any preceding implementation form of the third aspect, detecting photons by a single-photon avalanche diode (SPAD) pixel array comprises resetting the SPAD pixel array in response to the signal generated in response to the digital output reaching the predetermined threshold, and wherein measuring the period comprises measuring a time interval between consecutive signals generated in response to the digital output reaching the predetermined threshold.

In a third implementation form of the method, according to the third aspect as such or any preceding implementation form of the third aspect, the method further comprising accumulating multiple measurements; and calculating an average based on the accumulated measurements.

In a fourth implementation form of the method, according to the third aspect as such or any preceding implementation form of the third aspect, the digital output increases monotonically over time following a cumulative distribution function of an exponential distribution until the predetermined threshold is reached.

In a fifth implementation form of the method, according to the third aspect as such or any preceding implementation form of the third aspect, a statistical distribution of the measured period follows a Gamma distribution that predicts a time before a specific number of photon detection events occur.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

The specification and drawings are, accordingly, to be regarded simply as an illustration of the disclosure as defined by the appended claims, and are contemplated to cover any and all modifications, variations, combinations, or equivalents that fall within the scope of the present disclosure.

What is claimed is:

1. A system for ambient light sensing, comprising:
a single-photon avalanche diode (SPAD) pixel array configured to detect photons;
an adder coupled to the SPAD pixel array, the adder configured to sum outputs from the SPAD pixel array to generate a digital output representing a number of SPAD pixels that have detected photons;
a comparator coupled to the adder, the comparator configured to generate a signal in response to the digital output from the adder reaching a predetermined threshold corresponding to a percentage of the SPAD pixel array that has detected photons;
a time-to-digital converter (TDC) coupled to the comparator, the TDC configured to measure a period between consecutive signals from the comparator; and
a feedback path from the comparator to the SPAD pixel array, the feedback path configured to reset the SPAD pixel array in response to the predetermined threshold being reached, wherein the measured period determines ambient light intensity.

2. The system of claim 1, wherein each SPAD pixel in the SPAD pixel array comprises:
a photodiode configured to detect photons;
a resistor coupled to the photodiode;
a buffer coupled to the photodiode; and
a transistor coupled to the photodiode, wherein the feedback path is coupled to a gate terminal of the transistor.

3. The system of claim 1, further comprising an accumulator coupled to the TDC, the accumulator comprising:
a second adder configured to add time measurements from the TDC; and
a memory coupled to the second adder, the memory configured to store an accumulated value of the time measurements.

4. The system of claim 1, wherein the predetermined threshold is configurable to optimize a balance between measurement accuracy and measurement time.

5. The system of claim 1, wherein the digital output of the adder increases monotonically over time following a cumulative distribution function of an exponential distribution until the predetermined threshold is reached.

6. The system of claim 1,
wherein measurement cycles automatically adjust to be shorter in bright light conditions and longer in dim light conditions,
wherein high-speed timing operations are localized to the TDC, and
wherein the system prevents saturation issues by adaptively adjusting measurement cycles based on photon detection rate.

7. The system of claim 1, wherein the SPAD pixel array comprises at least one hundred SPAD pixels, and wherein the predetermined threshold corresponds to between 10 percent and 90 percent of the SPAD pixel array.

8. A system for ambient light sensing, comprising:
a single-photon avalanche diode (SPAD) pixel array configured to detect photons;
a controller configured to generate an enable signal;
a plurality of transistors, each transistor having a gate terminal coupled to the controller to receive the enable signal, wherein each transistor is coupled to a respective SPAD pixel in the SPAD pixel array;
an adder coupled to the SPAD pixel array, the adder configured to sum outputs from the SPAD pixel array to generate a digital output representing a number of SPAD pixels that have detected photons;
a comparator coupled to the adder, the comparator configured to generate a comparator signal in response to the digital output from the adder reaching a predetermined threshold corresponding to a percentage of the SPAD pixel array that has detected photons; and
a time-to-digital converter (TDC) coupled to the controller and the comparator, the TDC configured to measure a period between the enable signal and the comparator signal, wherein the measured period determines ambient light intensity.

9. The system of claim 8, wherein each SPAD pixel in the SPAD pixel array comprises:
a photodiode configured to detect photons;
a resistor coupled to the photodiode; and
a buffer coupled to the photodiode.

10. The system of claim 8, further comprising an accumulator coupled to the TDC, the accumulator comprising:
a second adder configured to add time measurements from the TDC; and
a memory coupled to the second adder, the memory configured to store an accumulated value of the time measurements.

11. The system of claim 8, wherein the controller is configured to generate the enable signal periodically.

12. The system of claim 8, wherein the predetermined threshold is configurable to optimize a balance between measurement accuracy and measurement time.

13. The system of claim 8, wherein the digital output of the adder increases monotonically over time following a cumulative distribution function of an exponential distribution until the predetermined threshold is reached.

14. The system of claim 8, wherein the controller comprises:
a processor;
a non-transitory memory coupled to the processor; and
an interface coupled to the processor and the non-transitory memory, wherein the interface is configured to provide the enable signal to the plurality of transistors and the TDC.

15. A method for ambient light sensing, comprising:
detecting photons by a single-photon avalanche diode (SPAD) pixel array;
summing outputs from the SPAD pixel array to generate a digital output representing a number of SPAD pixels that have detected photons;
comparing the digital output to a predetermined threshold corresponding to a percentage of the SPAD pixel array;
generating a signal in response to the digital output reaching the predetermined threshold;
measuring a period related to the signal; and
determining ambient light intensity based on the measured period.

16. The method of claim 15, wherein detecting photons by the SPAD pixel array comprises providing an enable signal from a controller to the SPAD pixel array, and wherein measuring the period comprises measuring a time interval between providing the enable signal and generating the signal in response to the digital output reaching the predetermined threshold.

17. The method of claim 15, wherein detecting photons by the SPAD pixel array comprises resetting the SPAD pixel array in response to the digital output reaching the predetermined threshold, and wherein measuring the period comprises measuring a time interval between consecutive signals generated in response to the digital output reaching the predetermined threshold.

18. The method of claim 15, further comprising:
accumulating multiple measurements; and
calculating an average based on the accumulated measurements.

19. The method of claim 15, wherein the digital output increases monotonically over time following a cumulative distribution function of an exponential distribution until the predetermined threshold is reached.

20. The method of claim 15, wherein a statistical distribution of the measured period follows a Gamma distribution that predicts a time before a specific number of photon detection events occur.
